(19) United States
(12) Patent Application Publication
(10) Pub. No.: US 2019/0107414 A1
(43) Pub. Date: Apr. 11, 2019

(54) INFORMATION PROCESSING APPARATUS, INFORMATION PROCESSING METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Xin JIN, Nagoya-shi (JP); Miharu HANAI, Obu-shi (JP)

(73) Assignee: TOYOTA JIDOSHA KABUSHIKI KAISHA, Toyota-shi (JP)

(21) Appl. No.: 16/125,622

(22) Filed: Sep. 7, 2018

(30) Foreign Application Priority Data
Oct. 5, 2017 (JP) 2017-195386

(51) Int. Cl. G01C 21/36; G06F 17/30; G01C 21/34

(52) U.S. Cl. CPC G01C 21/3688; G06F 17/30864; G01C 21/3484; G01C 21/3697; G01C 21/3453

(57) ABSTRACT

An information processing apparatus includes an acquisition unit configured to acquire a departure place and a destination designated by a user, a facility search unit configured to search for one or more facilities to pass through between the departure place and the destination among facilities within a predetermined range of the departure place to the destination based on a predetermined search condition, and a route search unit configured to search for a route from the departure place to the destination with one or more facilities searched by the facility search unit as a via-point.

### INCORPORATION BY REFERENCE

The disclosure of Japanese Patent Application No. 2017-195386 filed on Oct. 5, 2017 including the specification, drawings and abstract is incorporated herein by reference in its entirety.

### BACKGROUND

### 1. Technical Field

The present disclosure relates to an information processing apparatus, an information processing method, and a non-transitory storage medium storing a program.

### 2. Description of Related Art

A technique that searches for a route from a departure place to a destination according to various conditions, such as congestion information, is known (for example, see Japanese Unexamined Patent Application Publication No. 2008-273275 (JP 2008-273275 A), Japanese Unexamined Patent Application Publication No. 2012-185181 (JP 2012-185181 A), Japanese Unexamined Patent Application Publication No. 2013-195131 (JP 2013-195131 A)).

### SUMMARY

However, in the related art, searching for a stopover facility, such as a leisure spot or a store, between the departure place and the destination has not been taken into consideration.

The disclosure provides a technique that can select a facility conforming to a condition as a stopover via-point (hereinafter, simply referred to as a “via-point”) between a departure place and a destination.

A first aspect of the disclosure relates to an information processing apparatus. The information processing apparatus includes: an acquisition unit configured to acquire a departure place and a destination, the departure place and the destination being designated by a first user; a facility search unit configured to search, based on a predetermined search condition, for one or more facilities to pass through between the departure place and the destination among facilities located within a predetermined range from a first route, the first route being a route from the departure place to the destination; and a route search unit configured to search for a second route from the departure place to the destination with the one or more facilities searched by the facility search unit as a via-point.

For this reason, it is possible to search for a route with a facility searched based on a predetermined condition as a via-point. Accordingly, it is possible to select a facility conforming to a condition as the via-point.

In the first aspect, the route search unit may be configured to search for the second route from the departure place to the destination with a facility selected by the first user among the one or more facilities searched by the facility search unit as the via-point.

For this reason, it is possible to search for a route with a facility selected by the user among facilities searched based on a predetermined condition as a via-point. Accordingly, it is possible to allow the user to select a desired facility as a via-point from facilities conforming to a condition.

In the first aspect, the facility search unit may be configured to search, based on (i) weather predicted for a position of each facility on a predicted arrival date and time to each facility, and (ii) predetermined recommended weather set in advance for each facility, for the one or more facilities to pass through between the departure place and the destination.

For this reason, it is possible to search for a route with a facility searched based on a condition of weather as a via-point. Accordingly, it is possible to select a facility or the like available even in rainy weather as a via-point, for example, on date and time on which rainy weather is predicted.

In the first aspect, the facility search unit may be configured to search, based on (i) a type of a vehicle of the first user and (ii) accessory information of each facility, the accessory information being related with a vehicle, for the one or more facilities to pass through between the departure place and the destination.

For this reason, for example, it is possible to search for a route with, as a via-point, a facility searched based on the vehicle of the user, a width of a parking space in each facility, or a width of a road on which the vehicle travels until arrival at each facility. Accordingly, for example, in a case where the vehicle of the user is a heavy vehicle, it is possible to select, as a via-point, a facility having a parking space for a heavy vehicle or a facility having a width of a road on which a heavy vehicle can travel.

In the first aspect, the facility search unit may be configured to search, based on an attribute of the first user, for the one or more facilities to pass through between the departure place and the destination.

For this reason, it is possible to search for a route with a facility searched based on the attribute of the user as a via-point. Accordingly, for example, in a case where the user is a person with family, it is possible to select a popular facility or the like with family as a via-point.

In the first aspect, the facility search unit may be configured to search, based on (i) a departure date and time designated by the first user and (ii) a predetermined recommended period set in advance for each facility or a business date and time of each facility, for the one or more facilities to pass through between the departure place and the destination.

For this reason, it is possible to search for a facility as a via-point based on the departure date and time designated by the user and the recommended period congenial to a visit to each facility set in advance for each facility or based on the departure date and time and the business date and time of each facility. Accordingly, for example, it is possible to select, as a via-point, a leisure spot recommended in the period of the departure date and time or a store that is in business on the predicted arrival date and time.

In the first aspect, the information processing apparatus may include a display controller configured to display an unavailable facility with warning display, the unavailable facility not being available on the departure date and time or on a predicted arrival date and time to each facility, among the one or more facilities.

For this reason, warning display is added and displayed to a facility not available on the departure date and time or the predicted arrival date and time to the facility among predetermined facilities to be searched. Accordingly, for example, in a case where a facility desired by the user is not available, it is possible to display, to the user, that a facility is not available.

In the first aspect, the acquisition unit may be configured to acquire a third route from the departure place to the destination and a via-point on the third route, the third rout being shared by a second user different from the first user through a social networking service; and the route search unit may be configured to, in a case where a facility of the via-point is an unavailable facility which is not available on the departure date and time or on a predicted arrival date and time to the facility, search for a fourth route not passing through the unavailable facility.

For this reason, in a case where shared route information from the departure place to the destination is used, and in a case where a facility of a via-point included in the route information from the departure place to the destination is not available, a route not passing through the facility is searched. Accordingly, it is possible to change shared route information from the departure place to the destination to more appropriate route information.

In the first aspect, the facility search unit may be configured to, based on at least one of (i) weather predicted for a position of each facility on the predicted arrival date and time to each facility, (ii) the departure date and time designated by the user and the predetermined recommended period set in advance for each facility or the business date and time of each facility, and (iii) an attribute of the user, determine that the facility of the via-point is the unavailable facility.

In the first aspect, the facility search unit may be configured to, based on at least one of (i) weather predicted for a position of each facility on the predicted arrival date and time to each facility, (ii) the departure date and time designated by the user and the predetermined recommended period set in advance for each facility or the business date and time of each facility, and (iii) an attribute of the user, calculate a score of the facility of the via-point, and in a case where the score is equal to or lower than a predetermined threshold, determine that the facility of the via-point is the unavailable facility.

In the first aspect, the facility search unit may be configured to search, based on the attribute of the first user including at least one of sex, age, a residential area, a vehicle type, a family structure, a moving history, and a destination setting history of the first user, for the one or more facilities to pass through between the departure place and the destination.

In the first aspect, the information processing apparatus may include a sharing unit configured to share the second route with a third user different from the first user, through a social networking service.

A second aspect of the disclosure relates to an information processing method. The information processing method includes, by an information processing apparatus, acquiring a departure place and a destination, the departure place and the destination being designated by a user; searching, based on a predetermined search condition, for one or more facilities to pass through between the departure place and the destination among facilities located within a predetermined range from a first route, the first route being a route from the departure place to the destination; and searching for a second route from the departure place to the destination with the one or more searched facilities as a via-point.

A third aspect of the disclosure relates to a non-transitory storage medium storing a program. The program causes an information processing apparatus to execute acquiring a departure place and a destination, the departure place and the destination being designated by a user; searching, based on a predetermined search condition, for one or more facilities to pass through between the departure place and the destination among facilities located within a predetermined range from a first route, the first route being a route from the departure place to the destination; and searching for a second route from the departure place to the destination with the one or more searched facilities as a via-point.

According to the aspects of the disclosure, it is possible to select a facility conforming to a condition as a via-point.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a configuration example of a communication system according to an embodiment;

FIG. 2 is a diagram showing a hardware configuration example of a server according to the embodiment;

FIG. 3 is a diagram showing an example of a functional block diagram of a terminal and a server according to the embodiment;

FIG. 4 is a sequence diagram showing an example of processing of the communication system according to the embodiment;

FIG. 5 is a diagram illustrating an example of a display screen of a terminal as a sharing source;

FIG. 6 is a sequence diagram showing an example of processing of the communication system 1 according to the embodiment;

FIG. 7 is a sequence diagram showing an example of processing of the communication system 1 according to the embodiment;

FIG. 8 is a flowchart showing an example of facility search processing of a server according to the embodiment; and

FIG. 9 is a diagram showing an example of facility data.

### DETAILED DESCRIPTION OF EMBODIMENTS

Hereinafter, an embodiment of the disclosure will be described referring to the drawings.

System Configuration

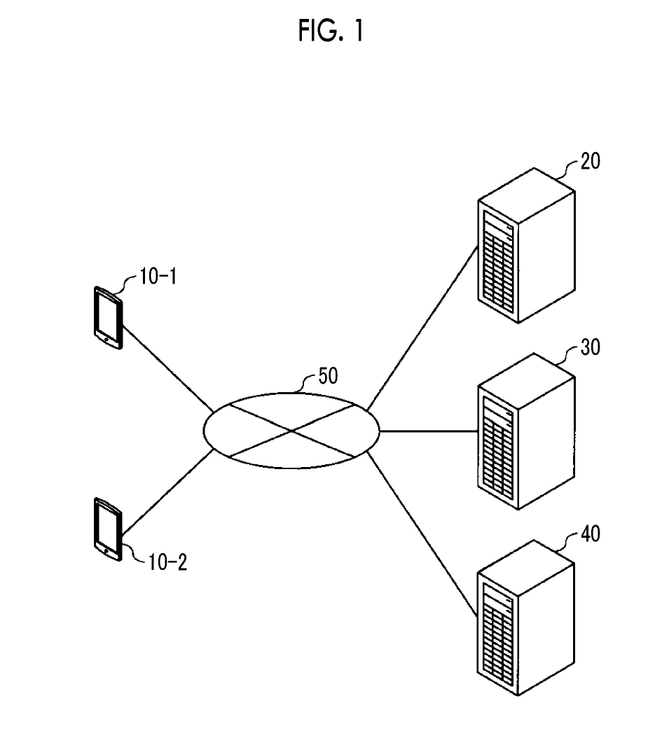

FIG. 1 is a diagram showing a configuration example of a communication system 1 according to an embodiment. In FIG. 1, the communication system 1 has terminals 10-1, 10-2 (hereinafter, in a case where there is no need for distinction from each other, simply referred to as “terminals 10”), a server 20, an SNS server 30, and a content providing server 40. The number of terminals 10 is not limited to two.

The terminals 10 and the server 20, and the terminals 10 and the SNS server 30 are connected in a communicable state, for example, through a network 50, such as the Internet, a mobile phone network, a wireless local area network (LAN), or a LAN. The server 20 and the content providing server 40 are connected in a communicable state through the network 50.

Each terminal 10 is, for example, an information processing apparatus (computer), such as a smartphone, a tablet personal computer (PC), a notebook PC, or a navigation device.

The terminal 10 acquires data of a map or a route from the server 20 using an application for route guidance (navigation), and performs navigation of moving using a vehicle, walking, a train, or the like. The terminal 10 transmits (uploads) information (route information) regarding a route, along which the user moves using the navigation, a route, along which the user is moving using the navigation, or a route, along which the user is scheduled to move using the navigation, to the server 20 according to a user's operation. The route information includes, for example, information regarding a moving route from a departure place to a destination, or the like. The route information may include a via-point, a departure time, an arrival time, and a pin, a comment, an image, or the like associated with a position on the route.

The terminal 10 performs chat, image sharing, and the like with a group of friends or the like using a social networking service (SNS) provided by the SNS server 30.

The server 20 is, for example, an information processing apparatus for a server, and provides a service, such as navigation, to the terminal 10. The server 20 selects a via-point according to a condition, such as a period (season), business date and time (available date and time), or weather, and provides information of the selected via-point to the terminal 10.

The server 20 shares the route information uploaded from the terminal 10 with users of other terminals 10 through the SNS server 30. The server 20 may share the route information uploaded from the terminal 10 with users of other terminals 10 not through the SNS server 30.

The SNS server 30 is, for example, an information processing apparatus for a server, and provides a social networking service, such as group chat, to the terminal 10. The SNS server 30 transmits the route information uploaded from the terminal 10 through the server 20 to other terminals 10 using the social networking service. The SNS server 30 may transmit the route information to other terminals 10 using social media including SNS, a blog, an image sharing site, and the like.

The content providing server 40 is, for example, an information processing apparatus for a server, and provides data, such as business hours of facilities, to the server 20.

Hardware Configuration

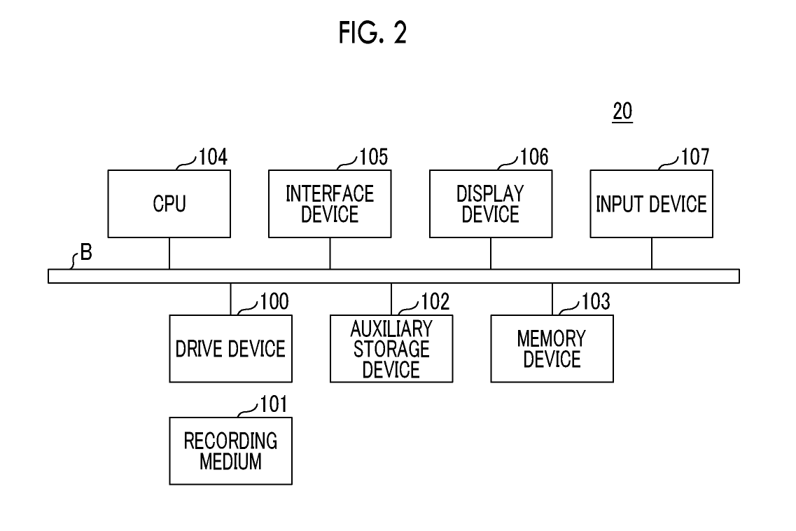

FIG. 2 is a diagram showing a hardware configuration example of the server 20 according to the embodiment. The server 20 of FIG. 2 has a drive device 100, an auxiliary storage device 102, a memory device 103, a central processing unit (CPU) 104, an interface device 105, and the like connected to one another through a bus B.

An information processing program that realizes processing in the server 20 is provided, for example, by a recording medium 101. In a case where the recording medium 101 having the information processing program recorded thereon is set in the drive device 100, the information processing program is installed from the recording medium 101 to the auxiliary storage device 102 through the drive device 100. However, the installation of the information processing program is not indispensably performed from the recording medium 101, and may be downloaded from another computer through the network. The auxiliary storage device 102 stores the installed information processing program, and stores needed files, data, and the like.

The memory device 103 is, for example, a random access memory (RAM), and in a case where there is a start instruction of the program, reads and stores the program from the auxiliary storage device 102. The CPU 104 realizes functions related to the server 20 according to the program stored in the memory device 103. The interface device 105 is used as an interface for connection to the network.

As an example of the recording medium 101, a portable recording medium, such as a compact disk-read only memory (CD-ROM), a digital versatile disc (DVD) disk, or a universal serial bus (USB) memory, is exemplified. As an example of the auxiliary storage device 102, a hard disk drive (HDD), a flash memory, or the like is exemplified. Both of the recording medium 101 and the auxiliary storage device 102 correspond to a computer-readable recording medium.

The hardware configurations of the terminal 10, the SNS server 30, and the content providing server 40 may be the same as that of the server 20.

Functional Configuration

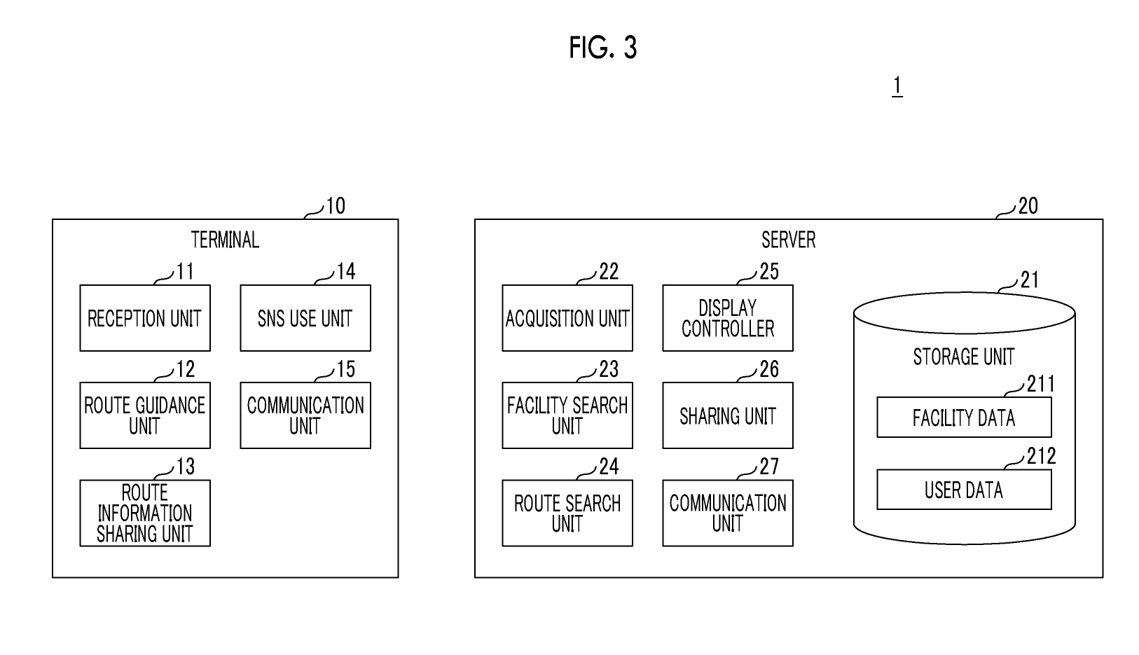

The functional configurations of the terminal 10 and the server 20 according to the embodiment will be described referring to FIG. 3. FIG. 3 is a diagram showing an example of a functional block diagram of the terminal 10 and the server 20 according to the embodiment.

Server 20

The server 20 has a storage unit 21. The storage unit 21 is realized using, for example, an auxiliary storage device or the like. The storage unit 21 stores facility data 211, user data 212, and the like. Data stored in the facility data 211 and the user data 212 will be described below.

The server 20 has an acquisition unit 22, a facility search unit 23, a route search unit 24, a display controller 25, a sharing unit 26, and a communication unit 27. The acquisition unit 22, the facility search unit 23, the route search unit 24, the display controller 25, the sharing unit 26, and the communication unit 27 represent functions that are realized by processing executed on the CPU 104 of the server 20 by one or more programs installed on the server 20.

The acquisition unit 22 acquires information of a departure place, a destination, and the like designated by the user of the terminal 10 from the terminal 10. Here, the departure place designated by the user includes a departure place designated by a user's operation, a current place automatically acquired by global positioning system (GPS) of the terminal 10 when the user performs a search operation of a route, or the like.

The facility search unit 23 searches for one or more facilities to pass through between the departure place and the destination among facilities within a predetermined range of the departure place to the destination based on a predetermined search condition. Here, the term “within the predetermined range” refers to, for example, within a range in which a moving time to the destination is not significantly delayed (an increase amount of the moving time is equal to or less than a predetermined threshold) even in a case where the vehicle passes through the facility or within a range in which a moving distance from the departure place to the destination is not significantly increased (an increase amount of the moving distance is equal to or less than a predetermined threshold).

The facility search unit 23 may determine the predetermined range integrally taking into consideration both of the increase amount of the moving time and the increase amount of the moving distance. The threshold regarding an allowable degree of the increase amount of the moving time and the increase amount of the moving distance within the predetermined range may be set in advance or may be calculated by the facility search unit 23 as a predetermined ratio (for example, within 10%) to a moving time or a moving distance from the departure place to the destination in a case where a via-point is not set. That is, the predetermined range may be a range of an increase amount to such a degree that a passenger does not feel like “it is impossible to actually pass through a facility”.

The route search unit 24 searches for a route from the departure place to the destination with one or more facilities searched by the facility search unit 23 as a via-point.

The display controller 25 makes the terminal 10 display information searched by the facility search unit 23 and the route search unit 24. The display controller 25 may make the terminal 10 display, with warning display, a facility not available on departure date and time or on predicted arrival date and time to the facility.

The sharing unit 26 allows route information of the user of the terminal 10 to be shared with other users. The sharing unit 26 makes the route information be shared with other users using the social networking service provided by the SNS server 30, for example.

The communication unit 27 performs communication with the terminal 10, the SNS server 30, and the content providing server 40. The communication unit 27 receives a route search request, a route sharing request, and the like from the terminal 10. The communication unit 27 transmits the route information to the SNS server 30 according to an instruction from the sharing unit 26.

Terminal 10

The terminal 10 has a reception unit 11, a route guidance unit 12, a route information sharing unit 13, an SNS use unit 14, and a communication unit 15. The above-described units represent functions that are realized by processing executed on the CPU 104 of the terminal 10 by one or more programs installed on the terminal 10.

The reception unit 11 receives an input operation from the user. The reception unit 11 receives an input of a departure place, a via-point, a destination, and the like, for example, in searching for route information.

The route guidance unit 12 performs route guidance using the route information received from the server 20. For example, the route guidance unit 12 may perform route guidance for a vehicle or may perform route guidance for walking.

The route information sharing unit 13 shares the route information used by the user of the terminal 10 with other terminals 10 using the server 20. For example, the route information sharing unit 13 acquires the route information from the server 20 or the SNS server 30. For example, the route information sharing unit 13 uploads the route information to the server 20.

The SNS use unit 14 performs chat, image sharing, and the like with a group including the users of other terminals 10 using the SNS server 30. In a case where an image of the route information shared through the SNS is selected by the user, the SNS use unit 14 can edit the selected route information by the route information sharing unit 13.

The communication unit 15 performs communication with the server 20 and the SNS server 30. For example, the communication unit 15 transmits a route search request, a route sharing request, and the like to the server 20.

Processing

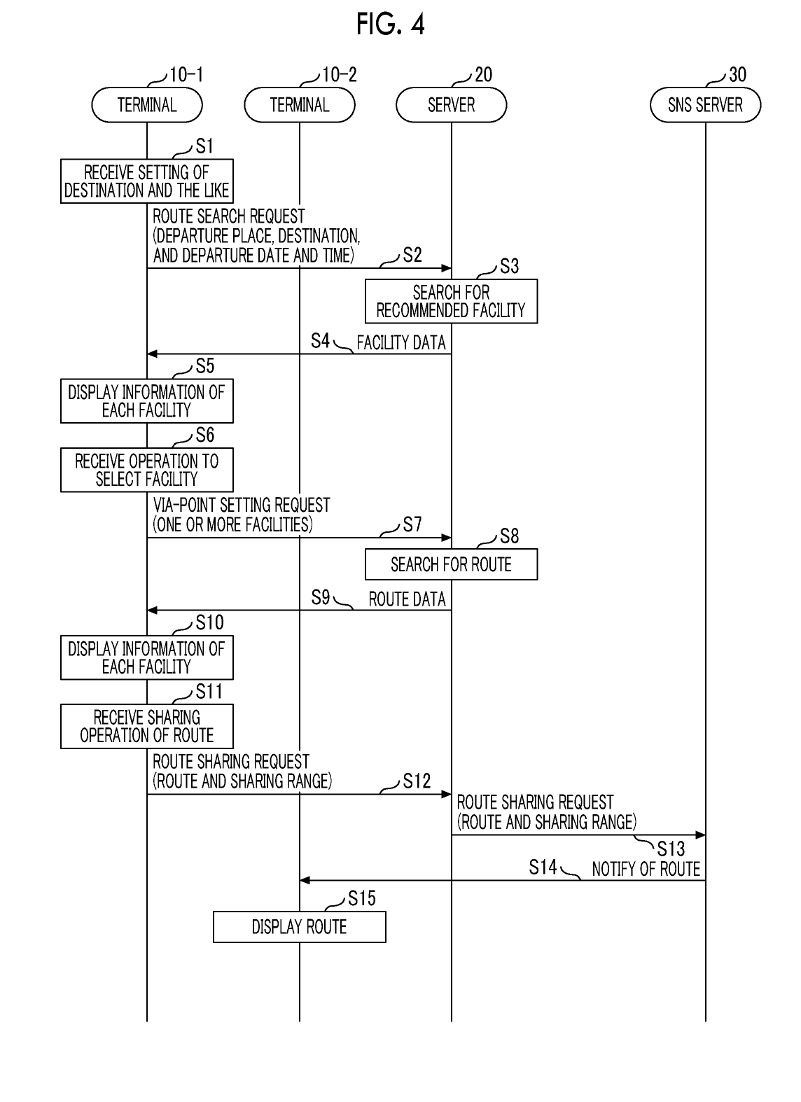

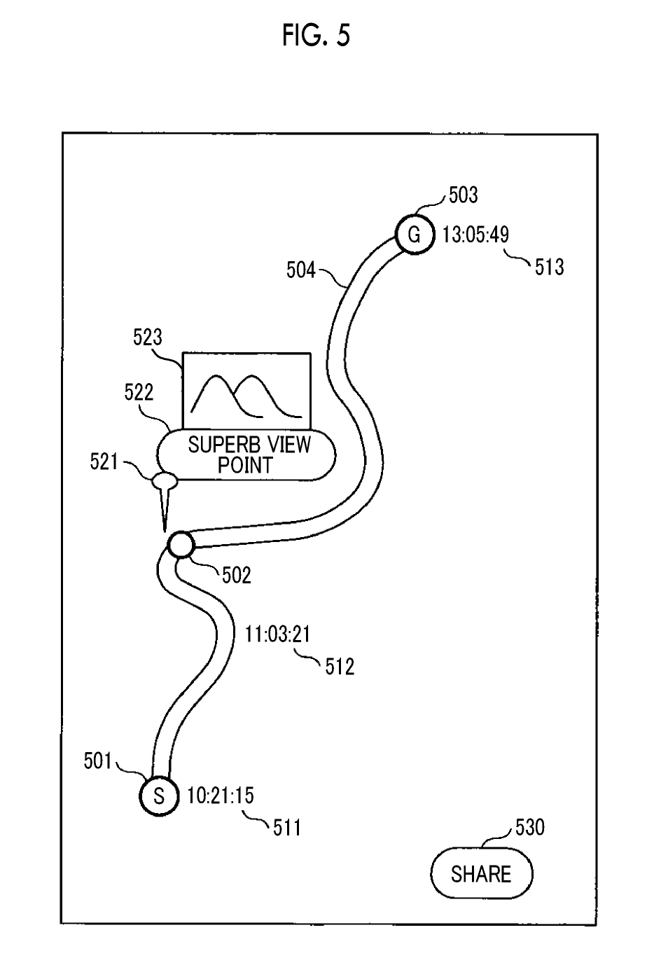

Processing of the communication system 1 according to the embodiment will be described referring to FIGS. 4 and 5. FIG. 4 is a sequence diagram showing an example of the processing of the communication system 1 according to the embodiment. FIG. 5 is a diagram illustrating an example of a display screen of the terminal 10-1 as a sharing source.

In Step 51, the reception unit 11 of the terminal 10-1 of the user as a sharing source of the route information receives setting of a destination, a departure place, departure date and time, and the like from the user. Here, the departure date and time can be set, whereby, for example, a drive plan for the weekend or the like can be created on weekdays or the like.

The reception unit 11 of the terminal 10-1 may receive setting of one or more via-points. In a case where designation of the departure place is not received from the user, a current position of the terminal 10 or a position set in advance may be set as a departure place. In a case where designation of the departure date and time is not received from the user, current date and time or date and time set in advance may be set as departure date and time.

Subsequently, the route guidance unit 12 of the terminal 10-1 transmits a route search request including setting data, such as the destination, to the server 20 (Step S2). With this, setting data, such as the destination, the departure place, and the departure date and time, is acquired by the acquisition unit 22 of the server 20.

Subsequently, the facility search unit 23 of the server 20 searches for one or more recommended facilities to pass through between the departure place and the destination (Step S3), and transmits information of one or more searched facilities to the terminal 10-1 (Step S4). Here, information of the facilities may include business date and time of the facilities, introductions of the facilities, uniform resource locators (URLs) of Web sites of the facilities, and the like.

Subsequently, the route guidance unit 12 of the terminal 10-1 displays information of each facility received from the server 20 (Step S5). Subsequently, the reception unit 11 of the terminal 10-1 receives an operation to select one or more facilities to pass through among the facilities from the user (Step S6). Subsequently, the route guidance unit 12 of the terminal 10-1 transmits a via-point setting request including data of one or more selected facilities to the server 20 (Step S7).

Subsequently, the route search unit 24 of the server 20 searches for a route (moving route or route) from the departure place to the destination passing through one or more facilities selected by the user (Step S8), and transmits data of the searched route to the terminal 10-1 (Step S9).

Subsequently, the route guidance unit 12 of the terminal 10-1 displays the route received from the server 20 (Step S10). Subsequently, the route information sharing unit 13 of the terminal 10-1 receives an operation to designate route information to be shared and a range of users sharing the route information from the user (Step S11).

In FIG. 5, as a display example of route information to be shared, an example of route information after the user of the terminal 10-1 actually moves from a departure place to a destination during a trip or the like is shown. In the example of FIG. 5, a route 504 from a departure place 501 to a destination 503 by way of a via-point 502, a time 511 for departure or scheduled for departure from the departure place 501, a time 512 for passing through or scheduled for passing through the via-point 502, a time 513 for arrival or scheduled for arrival at the destination 503, a pin 521, a comment 522, an image 523, and a share button 530 are displayed. The pin 521, the comment 522, and the image 523 are information indicating a position, a comment of the user relating to the position, and an image relating to the position input by the user of the terminal 10-1, or the like before, during, or after moving from the departure place to the destination.

Here, the route information sharing unit 13 of the terminal 10-1 receives designation of an identification (ID) of each user included in a group sharing the route information as the range of users sharing the route information. Furthermore, the route information sharing unit 13 of the terminal 10-1 may receive designation of a talk room (chat room) of the group sharing the route information in the SNS server 30.

Subsequently, the route information sharing unit 13 of the terminal 10-1 transmits a route sharing request including data of the route information and the range to the server 20 (Step S12).

Subsequently, the sharing unit 26 of the server 20 transmits the route information and a range of users sharing the route information to the SNS server 30 (Step S13). Here, the sharing unit 26 of the server 20 may convert the ID of each user included in the group sharing the route received in Step S11 to the ID of each user managed on the SNS server 30 and transmit the ID of each user managed on the SNS server 30 as the range of users sharing the route information. In this case, a correspondence table of the ID of the user managed on the server 20 and the ID of the user managed on the SNS server 30 may be set in the server 20 in advance.

Subsequently, the SNS server 30 transmits the received route information of the terminal 10-2 of each user included in the group sharing the route (Step S14).

Subsequently, the SNS use unit 14 of the terminal 10-2 of the user as a sharing destination displays the route information received from the SNS server 30 on a talk room screen of the group designated from the user of the terminal 10-1 (Step S15).

The route information sharing unit 13 of the terminal 10-2 performs edition, such as addition or deletion, of a pin, a comment, an image, and the like associated with a position on the route in the shared route information according to an operation from the user. In this case, the route information sharing unit 13 of the terminal 10-2 can upload the edited route information to the server 20 and can allow the route information to be shared with the terminal 10-1. The route information sharing unit 13 of the terminal 10 may directly upload the route information to the SNS server 30 instead of uploading the route information to the SNS server 30 through the server 20.

### Modification Example of Facility Selection of User

In the above-described example, an example where each facility to pass through can be selected by the user has been described. Instead, the facility search unit 23 of the server 20 may select a recommended facility and may allow the user to select whether or not to use a route passing through the selected facility.

### Modification Example 1 in Case where Shared Route Information is Used

In the above-described example, an example where the route is searched using the destination and the like designated by the user has been described. Instead, route information shared with other users received from the SNS server 30 or the like may be used using the SNS.

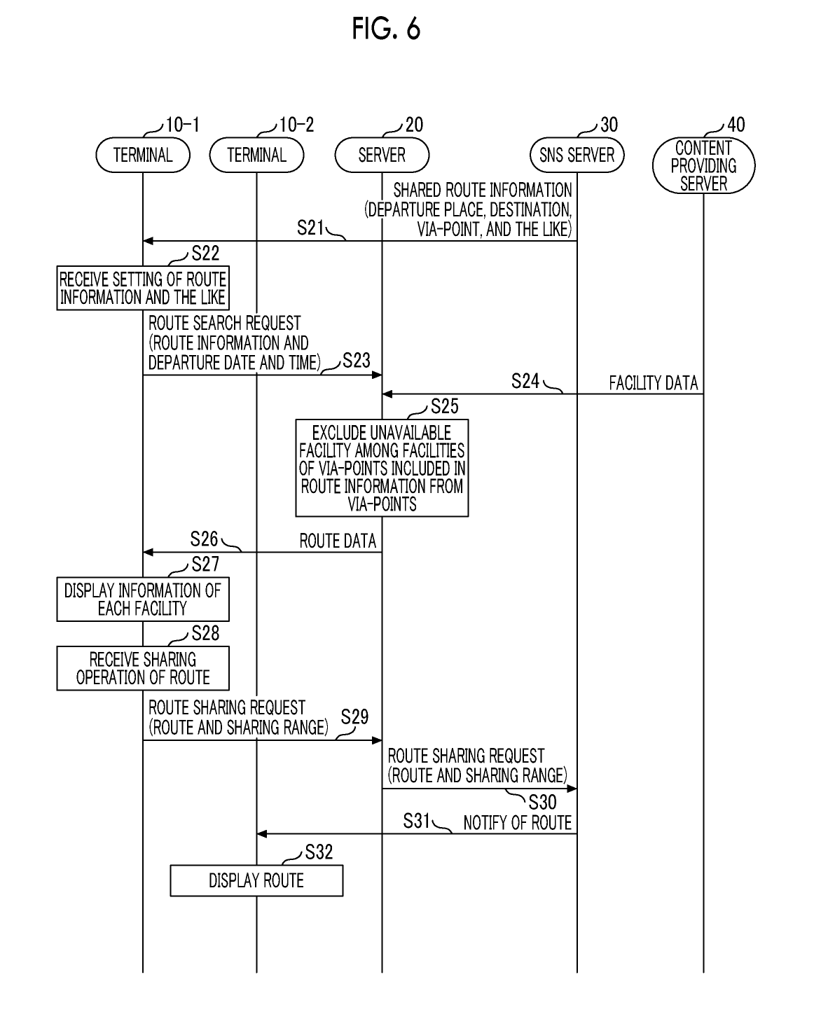

Processing in the communication system 1 according to the embodiment in a case where shared route information is used will be described referring to FIG. 6. FIG. 6 is a sequence diagram showing an example of processing of the communication system 1 according to the embodiment.

In Step S21, the SNS use unit 14 of the terminal 10-1 acquires route information shared with users other than the user of the terminal 10-1 from the SNS server 30.

Subsequently, the reception unit 11 of the terminal 10-1 receives the shared route information and setting of departure date and time and the like from the user (Step S22).

Subsequently, the route guidance unit 12 of the terminal 10-1 transmits a route search request including the shared route information and setting data, such as the departure date and time, to the server 20 (Step S23). With this, setting data, such as destination, the departure place, and the departure date and time, is acquired by the acquisition unit 22 of the server 20. Here, the shared route information includes information of a route from the departure place to the destination, a via-point on the route, and the like. With this, the acquisition unit 22 of the server 20 acquires the shared route information from the terminal 10-1.

Subsequently, the facility search unit 23 of the server 20 acquires facility data 211 of the via-point included in the shared route information from the content providing server 40 (Step S24). Here, as described below, facility data 211 of the via-point acquired from the content providing server 40 includes data of business date and time or the like. Data of the business date and time or the like of each facility may be acquired by the terminal 10 from the content providing server 40 through the SNS server 30, and may be transmitted from the terminal 10 to the server 20 while being included in the route search request of Step S22.

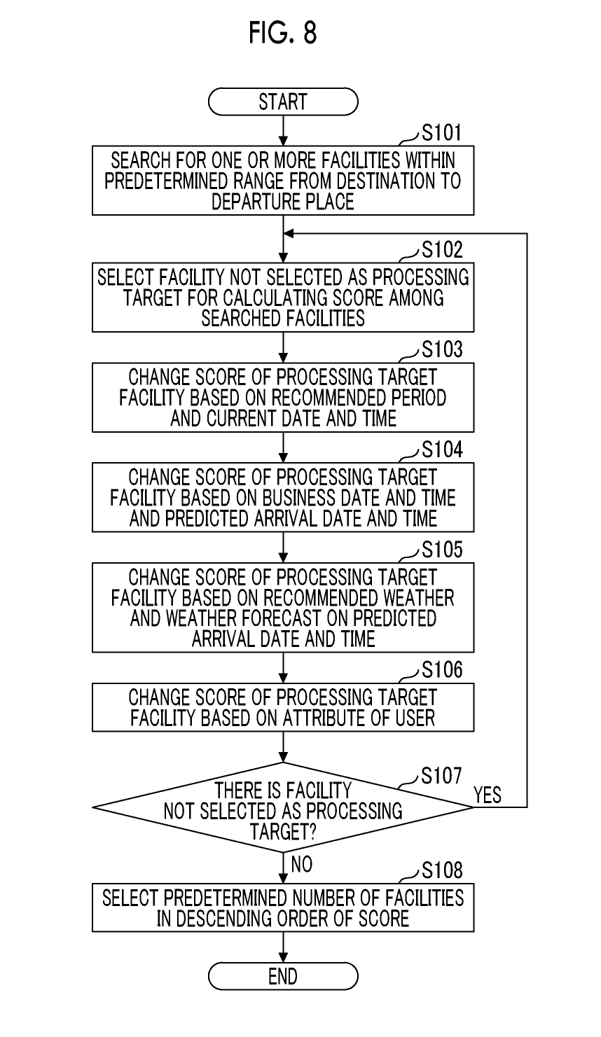

Subsequently, the facility search unit 23 of the server 20 excludes a facility not available on the departure date and time or the predicted arrival date and time to the facility among the facilities of the via-points included in the shared route information from the via-points based on data of the business date and time or the like of each facility acquired from the content providing server 40 (Step S25). Here, the unavailable facility is, for example, a facility that is not recommended due to a period or weather, a facility that is not in business on the predicted arrival date and time to the facility, or the like. The facility search unit 23 of the server 20 may perform processing of Steps S102 to S107 of facility search processing shown in FIG. 8 described below, for example, for each via-point included in the shared route information, and may define a facility having a calculated score equal to or less than a predetermined threshold as an unavailable facility.

Processing of Steps S26 to S32 is the same as the processing of Steps S9 to S15 of FIG. 4 described above.

The facility search unit 23 may add a facility that is recommended due to a period or weather or a facility that is in business on the predicted arrival date and time to the facility, instead of the excluded facility. The route search unit 24 researches for a route from the departure place to the destination without passing through the facility excluded by the facility search unit 23, and the display controller 25 makes the terminal 10 display the researched route information. The display controller 25 may perform warning display for displaying a via-point excluded by the facility search unit 23 since a facility of the via-point is not available on the departure date and time or the predicted arrival date and time to the facility while adding warning information including information indicating a reason that the facility is not available or while adding a predetermined warning mark.

In a case where a facility of a via-point included in the shared route information is not recommended by the facility search unit 23 due to a period or weather, or in a case where a facility of a via-point included in the shared route information is not in business on the predicted arrival date and time to the facility, the display controller 25 may make the terminal 10 display a message for prompting to change of departure date and time such that a period or weather comes during which the facility is recommended or departure date and time such that predicted arrival date and time is included in business date and time.

### Modification Example 2 in Case where Shared Route Information is Used

In Modification Example 1 in a case where the shared route information is used, an example where the shared route information designated by the user is used has been described. Instead, the server 20 may receive and use route information conforming to a destination designated by the user among route information shared on the SNS or the like from the SNS server 30 or the like.

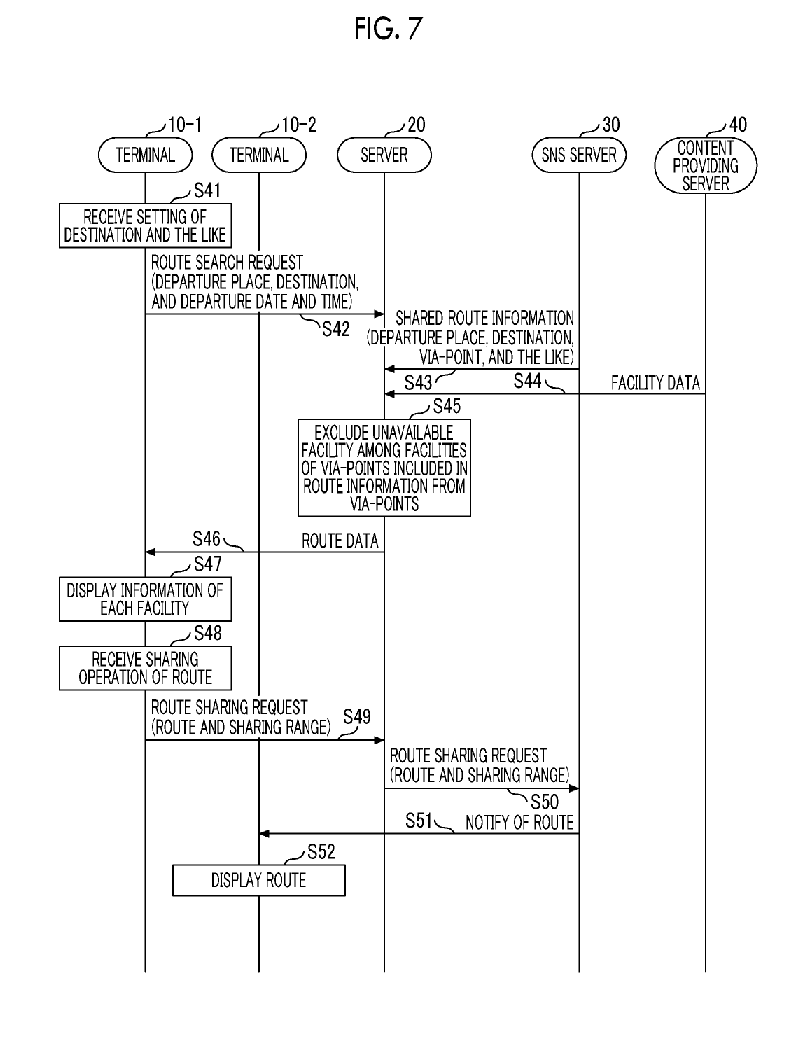

Processing in the communication system 1 according to the embodiment in a case where shared route information is used will be described referring to FIG. 7. FIG. 7 is a sequence diagram showing an example of processing of the communication system 1 according to the embodiment.

Processing of Steps S41 and S42 is the same as the processing of Steps 51 and S2 of FIG. 4 described above.

In Step S43, the facility search unit 23 of the server 20 acquires one or more pieces of shared route information conforming to a destination acquired in Step S42 from the SNS server 30. Here, in a case where a moving time or a moving distance between the destination acquired in Step S42 and a destination included in the shared route information is equal to or less than a predetermined threshold, the facility search unit 23 of the server 20 may determine that the two destinations conform to each other.

Subsequently, the facility search unit 23 of the server 20 acquires facility data 211 of a via-point included in the shared route information from the content providing server 40 (Step S44).

Processing of Steps S45 to S52 is the same as the processing of Steps S25 to S32 of FIG. 6 described above. The facility search unit 23 of the server 20 may search for a recommended facility from one or more via-points included in one or more pieces of shared route information and may allow the user to select the recommended facility, instead of excluding one or more via-points included in one or more pieces of shared route information.

Facility Search Processing

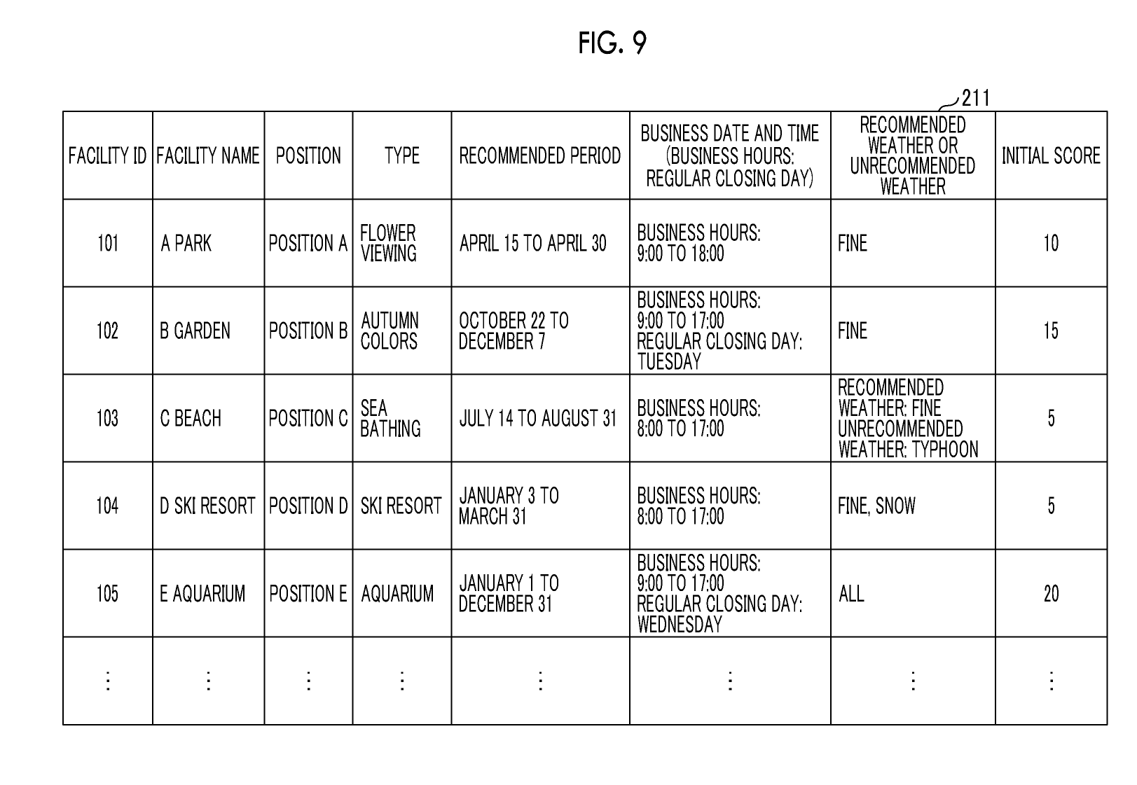

Processing for searching one or more recommended facilities to pass through between a departure place and a destination in the facility search unit 23 of the server 20 in Step S3 described above will be described referring to FIGS. 8 and 9. FIG. 8 is a flowchart showing an example of the facility search processing of the server 20 according to the embodiment. FIG. 9 is a diagram showing an example of facility data 211.

In Step S101, the facility search unit 23 refers to facility data 211 and searches for one or more facilities able to pass through between the departure place and the destination (within a predetermined range of the departure place to the destination). Here, for example, a facility where the ratio of a needed time (moving time) from the destination to the departure place passing through a facility to a needed time from the destination to the departure place without passing through a facility is equal to or less than a predetermined threshold is searched.

In facility data 211, items of a facility ID, a facility name, a position, a type, a recommended period, business date and time, recommended weather or unrecommended weather, and an initial score are recorded. The facility ID is identification information of a facility. The facility name is a name of a facility. The position is a position of a facility indicated by a latitude, a longitude, and the like. The type is a type of a facility. The recommended period is a period (recommended period) during which a stopover at a facility is recommended. The business date and time is business date and time of a facility. The recommended weather is weather during which a stopover at a facility is recommended. The unrecommended weather is weather during which a stop at a facility is not recommended. The initial score is an initial value of a score set in advance. The server 20 may acquire and store at least a part of data included in facility data 211 from the content providing server 40.

Subsequently, the facility search unit 23 selects, as a processing target, a facility not selected as a target of the following processing for calculating a score among the facilities searched in Step S101 (Step S102). Hereinafter, the facility selected as a processing target is referred to as a “processing target facility”.

Subsequently, the facility search unit 23 refers to facility data 211 and changes a score of the processing target facility based on the recommended period associated with the processing target facility and the current date and time (Step S103).

Here, for example, in a case where the current date and time is included in the recommended period associated with the processing target facility, the score of the processing target facility is increased. In a case where the current date and time is not included in the recommended period associated with the processing target facility, the score of the processing target facility is decreased. In the example of FIG. 9, for example, in a case where the departure date and time is April 16, a score of a facility of a facility ID “101” where the departure date and time is included in the recommended period of the facility is increased.

Subsequently, the facility search unit 23 refers to facility data 211 and changes the score of the processing target facility based on the business date and time associated with the processing target facility and date and time (predicted arrival date and time) on which arrival at the processing target facility is predicted (Step S104). The facility search unit 23 makes the route search unit 24 calculate the predicted arrival date and time to the processing target facility. The route search unit 24 may calculate the predicted arrival date and time based on congestion information of a road, the type, such as displacement, of the vehicle of the user.

Here, for example, the predicted arrival date and time to the processing target facility is not a regular closing day of the processing target facility, and is earlier than a business close time by a predetermined time or more, the score of the processing target facility is increased. For example, in a case where the predicted arrival date and time to the processing target facility is a regular closing day of the processing target facility and in a case where the predicted arrival date and time is not earlier than the business close time by the predetermined time or more, the score of the processing target facility is decreased. In the example of FIG. 9, for example, in a case where the departure date and time is Tuesday, a score of a facility of a facility ID “102” where Tuesday is a regular closing day is decreased.

Subsequently, the facility search unit 23 refers to facility data 211 and changes the score of the processing target facility based on the recommended weather associated with the processing target facility and a weather forecast of an area where the position of the processing target facility is included on date and time on which arrival at the processing target facility is predicted (Step S105). Here, in a case where weather based on the weather forecast is included in the recommended weather, the score of the processing target facility is increased. In a case where weather based on the weather forecast is included in the unrecommended weather, the score of the processing target facility is decreased. In the example of FIG. 9, for example, in a case where the weather forecast of the area on the predicted arrival date and time is “rainy weather”, a score of a facility of a facility ID “105” where weather “all” is included in the recommended weather is increased. With this, for example, in a case of rainy weather, an all-weather type facility is easily recommended. A facility, such as a beach or a riverside camp, which is not available due to a typhoon or the like is hardly recommended during the typhoon or the like.

Subsequently, the facility search unit 23 refers to user data 212 and changes the score of the processing target facility based on an attribute of the user (Step S106). Here, in user data 212, data of items of sex, age, a residential area, a vehicle type, a family structure, a moving history, a destination setting history, and the like of the user of the terminal 10 is included.

The vehicle type is a type of a vehicle owned by the user. The vehicle type may include, for example, a light vehicle, a standard-sized passenger vehicle, a heavy vehicle, and the like. The family structure includes, for example, the presence or absence of a spouse, the number of children, and the like. The moving history is a history that the user moves through traveling of the vehicle while using a navigation function of the route guidance unit 12 of the terminal 10. The destination setting history is a history of a destination set using the navigation function. The facility search unit 23 classifies each user into each cluster based on the attribute of the each user, for example, using a k-means clustering. Then, a facility that a comparatively large number of users who belong to each cluster go, a popular facility that receives comparatively high evaluation, or the like is determined based on the moving histories, the destination setting histories, questionnaires, or the like of the users who belong to each cluster. Then, in a case where the processing target facility is a popular facility in a cluster to which one user belongs, the score of the processing target facility may be increased. The facility search unit 23 may increase the score of the processing target facility recommended to the user, for example, using data that artificial intelligence (AI) mechanically learns through deep learning or the like.

Subsequently, the facility search unit 23 determines whether or not there is a facility not selected as a processing target among the facilities searched in Step S101 (Step S107). In a case where there is an unselected facility (in Step S107, YES), the process progresses to Step S102. In a case where there is no unselected facility (in Step S107, NO), the facility search unit 23 selects a predetermined number of facilities among the facilities searched in Step S101 in a descending order of the score of the processing target facility (Step S108), and ends the process. With this, it is possible to select a facility conforming to a condition as a via-point.

### Modification Example 1 of Facility Search Processing

The facility search unit 23 may change the score of the processing target facility further based on the vehicle type (the type of the vehicle) of the user and vehicle-related accessory information of each facility. In this case, for example, the vehicle-related accessory information of each facility is stored in facility data 211. Then, the facility search unit 23 searches for a facility based on the vehicle type of the user and a width of a parking space in a parking lot of each facility or a width of a road, on which the vehicle travels until arrival at each facility, stored in user data 212. In this case, for example, in a case where the vehicle of the user is a heavy vehicle, the facility search unit 23 may select a facility that has a parking space for a heavy vehicle, a facility that has a width of a road, on which a heavy vehicle can travel, or the like as a via-point.

### Modification Example 2 of Facility Search Processing

In a case where a route is searched using route information shared with other users received from the SNS server 30 or the like using the SNS or the like, the facility search unit 23 may search for a facility to pass through based on information of the SNS. In this case, for example, the facility search unit 23 may analyze a message in a group chat where route information is shared and may increase a score of a facility mentioned from a member of a group in the group chat. For example, as in FIG. 5, in regard to a facility of a via-point included in route information to be shared, in a case where a pin, a comment, and an image indicating the position of the facility are input, the score of the facility may be increased.

Although the embodiment of the disclosure has been described above in detail, the disclosure is not limited to a specific embodiment described above, and various modifications and alterations may be made without departing from the spirit and scope of the disclosure described in the claims.

The functional units of the terminal 10 and the server 20 may be realized by, for example, cloud computing constituted of one or more computers. At least a part of the functions of the terminal 10 and the SNS server 30 may be provided in the server 20. At least a part of the functional units of the server 20 may be provided in the terminal 10.

In the embodiment of the disclosure, the terminal 10 and the server 20 is an example of an information processing apparatus.

What is claimed is:

1. An information processing apparatus comprising:
an acquisition unit configured to acquire a departure place and a destination, the departure place and the destination being designated by a first user;
a facility search unit configured to search, based on a predetermined search condition, for one or more facilities to pass through between the departure place and the destination among facilities located within a predetermined range from a first route, the first route being a route from the departure place to the destination; and
a route search unit configured to search for a second route from the departure place to the destination with the one or more facilities searched by the facility search unit as a via-point.

2. The information processing apparatus according to claim 1, wherein the route search unit is configured to search for the second route from the departure place to the destination with a facility selected by the first user among the one or more facilities searched by the facility search unit as the via-point.

3. The information processing apparatus according to claim 1, wherein the facility search unit is configured to search, based on (i) weather predicted for a position of each facility on a predicted arrival date and time to each facility, and (ii) predetermined recommended weather set in advance for each facility, for the one or more facilities to pass through between the departure place and the destination.

4. The information processing apparatus according to claim 1, wherein the facility search unit is configured to search, based on (i) a type of a vehicle of the first user and (ii) accessory information of each facility, the accessory information being related with a vehicle, for the one or more facilities to pass through between the departure place and the destination.

5. The information processing apparatus according to claim 1, wherein the facility search unit is configured to search, based on an attribute of the first user, for the one or more facilities to pass through between the departure place and the destination.

6. The information processing apparatus according to claim 1, wherein the facility search unit is configured to search, based on (i) a departure date and time designated by the first user and (ii) a predetermined recommended period set in advance for each facility or a business date and time of each facility, for the one or more facilities to pass through between the departure place and the destination.

7. The information processing apparatus according to claim 6, further comprising a display controller configured to display an unavailable facility with warning display, the unavailable facility not being available on the departure date and time or on a predicted arrival date and time to each facility, among the one or more facilities.

8. The information processing apparatus according to claim 6, wherein:
the acquisition unit is configured to acquire a third route from the departure place to the destination and a via-point on the third route, the third rout being shared by a second user different from the first user through a social networking service; and
the route search unit is configured to, in a case where a facility of the via-point is an unavailable facility which is not available on the departure date and time or on a predicted arrival date and time to the facility, search for a fourth route not passing through the unavailable facility.

9. The information processing apparatus according to claim 8, wherein the facility search unit is configured to, based on at least one of (i) weather predicted for a position of each facility on the predicted arrival date and time to each facility, (ii) the departure date and time designated by the first user and the predetermined recommended period set in advance for each facility or the business date and time of each facility, and (iii) an attribute of the first user, determine that the facility of the via-point is the unavailable facility.

10. The information processing apparatus according to claim 8, wherein the facility search unit is configured to,
based on at least one of (i) weather predicted for a position of each facility on the predicted arrival date and time to each facility, (ii) the departure date and time designated by the first user and the predetermined recommended period set in advance for each facility or the business date and time of each facility, and (iii) an attribute of the first user, calculate a score of the facility of the via-point, and
in a case where the score is equal to or lower than a predetermined threshold, determine that the facility of the via-point is the unavailable facility.

11. The information processing apparatus according to claim 5, wherein the facility search unit is configured to search, based on the attribute of the first user including at least one of sex, age, a residential area, a vehicle type, a family structure, a moving history, and a destination setting history of the first user, for the one or more facilities to pass through between the departure place and the destination.

12. The information processing apparatus according to claim 1, further comprising
a sharing unit configured to share the second route with a third user different from the first user, through a social networking service.

13. An information processing method comprising:
by an information processing apparatus, acquiring a departure place and a destination, the departure place and the destination being designated by a user;
searching, based on a predetermined search condition, for one or more facilities to pass through between the departure place and the destination among facilities located within a predetermined range from a first route, the first route being a route from the departure place to the destination; and
searching for a second route from the departure place to the destination with the one or more facilities as a via-point.

14. A non-transitory storage medium storing a program causing an information processing apparatus to execute:
acquiring a departure place and a destination, the departure place and the destination being designated by a user;
searching, based on a predetermined search condition, for one or more facilities to pass through between the departure place and the destination among facilities located within a predetermined range from a first route, the first route being a route from the departure place to the destination; and
searching for a second route from the departure place to the destination with the one or more facilities as a via-point.
